(19) United States
(12) Patent Application Publication
(10) Pub. No.: US 2004/0217311 A1
(43) Pub. Date: Nov. 4, 2004

(54) Fully-sealing throttle valve

(75) Inventor: Wen-Chih Lu, Tainan (TW)

Correspondence Address: TUNG & ASSOCIATES, Suite 120, 838 W. Long Lake Road, Bloomfield Hills, MI, 48302, US

(73) Assignee: Taiwan Semiconductor Manufacturing Co., Ltd.

(21) Appl. No.: 10/425,334

(22) Filed: Apr. 29, 2003

(51) Int. Cl. F16K 31/02; F16K 47/00

(52) U.S. Cl. 251/122; 251/129.11

(57) ABSTRACT

A new and improved fully-sealing throttle valve which is capable of selectively varying or stopping the flow of gas from one gas flow channel to an adjacent gas flow channel. The throttle valve includes a valve body in which is slidably disposed a tapered valve plug having a tapered plug sealing surface. A motor operably engages the valve plug for progressively moving the valve plug toward a correspondingly-tapered, complementary valve plug seat in the valve body in order to impede flow of gas between the plug sealing surface and the valve plug seat, through the valve body. The motor is capable of moving the plug sealing surface of the valve plug in firm engagement with the valve plug seat of the valve body to selectively prevent further flow of gas through the valve body.

### FIELD OF THE INVENTION

The present invention relates to throttle valves for regulating the flow of a fluid through conduit or channel. More particularly, the present invention relates to a combined isolation valve and fully-sealing throttle valve which is particularly suitable for controlling the flow of gases in a plasma etching system used in the fabrication of integrated circuits.

### BACKGROUND OF THE INVENTION

Integrated circuits are formed on a semiconductor substrate, which is typically composed of silicon. Such formation of integrated circuits involves sequentially forming or depositing multiple electrically conductive and insulative layers in or on the substrate. Etching processes may then be used to form geometric patterns in the layers or vias for electrical contact between the layers. Etching processes include “wet” etching, in which one or more chemical reagents are brought into direct contact with the substrate, and “dry” etching, such as plasma etching.

Various types of plasma etching processes are known in the art, including plasma etching, reactive ion (RI) etching and reactive ion beam etching. In each of these plasma processes, a gas is first introduced into a reaction chamber and then plasma is generated from the gas. This is accomplished by dissociation of the gas into ions, free radicals and electrons by using an RF (radio frequency) generator, which includes one or more electrodes. The electrodes are accelerated in an electric field generated by the electrodes, and the energized electrons strike gas molecules to form additional ions, free radicals and electrons, which strike additional gas molecules, and the plasma eventually becomes self-sustaining. The ions, free radicals and electrons in the plasma react chemically with the layer material on the semiconductor wafer to form residual products which leave the wafer surface and thus, etch the material from the wafer.

As discussed above, plasma includes high-energy ions, free radicals and electrons which react chemically with the surface material of the semiconductor wafer to form reaction produces that leave the wafer surface, thereby etching a geometrical pattern or a via in a wafer layer. Plasma intensity depends on the type of etchant gas or gases used, as well as the etchant gas pressure and temperature and the radio frequency generated at an electrode in the process chamber by an RF generator. If any of these factors changes during the process, the plasma intensity may increase or decrease with respect to the plasma intensity level required for optimum etching in a particular application. Decreased plasma intensity results in decreased, and thus incomplete, etching. Increased plasma intensity, on the other hand, can cause overetching and plasma-induced damage of the wafers. Plasma-induced damage includes trapped interface charges, material defects migration into bulk materials, and contamination caused by the deposition of etch products on material surfaces. Etch damage induced by reactive plasma can alter the qualities of sensitive IC components such as Schottky diodes, the rectifying capability of which can be reduced considerably. Heavy-polymer deposition during oxide contact hole etching may cause high-contact resistance.

Throttle valves are known in the art for controlling the rate of flow of a gas through a channel. In a plasma etcher used in the etching of material layers on semiconductor wafers, a throttle valve is a component part of a pressure servo system which leads from the chamber and conducts gases from the chamber to control the intra-chamber gas pressures. Throttle valves typically include a generally cylindrical valve body for allowing gas or other fluid to flow therethrough. A movable valve disk disposed inside the valve body is provided on a rotatable shaft that is engaged by a step motor. By rotating the valve disk from a position parallel to the flow direction to a position perpendicular to the flow direction of the gas, the step motor decreases the rate of flow of the gas through the valve body. While it is positioned perpendicular to the gas flow direction the valve disk impedes, rather than prevents, flow of the gas through the valve body. It is desirable in many applications during semiconductor fabrication to prevent, rather than merely regulate, flow of a gas from one channel to another. Isolation valves are commonly used in the industry for this purpose.

Referring to FIG. 1, a pressure servo system 10 of a dry etching chamber 12 used in the semiconductor industry is shown. The pressure servo system 10 includes a pumping line 14 which leads from the chamber 12. A throttle valve 16 and an isolation valve 22 are provided in series in the pumping line 14. A pressure controller 32 is operably connected to the control elements of the throttle valve 16 and the isolation valve 22, respectively. A manometer 34 is connected to the chamber 12 for measuring gas pressures therein.

As shown in FIG. 2, the throttle valve 16 typically includes a valve body 17 having a valve interior 18. A valve disk 19 is mounted inside the valve interior 18 on a motor shaft 20 that is engaged by a stepper motor (not shown). Gas 33 is introduced into the side of the chamber 12 through gas entry ports (not shown), and the gas 33 is drawn from the chamber 12 through the pumping line 14 by operation of a pump (not shown). By operation of the pressure controller 32, the motor shaft 20 is actuated to rotate the valve disk 19 to various orientations with respect to the direction of flow of gas 33 flowing through the valve body 17 in order to control the rate of flow of the gas 33 through the pumping line 14, and thus, the interior gas pressures of the chamber 12.

As shown in FIG. 3, the isolation valve 22 typically includes a valve body 23 having a valve interior 24 which communicates with a gas entry arm 25 and a gas exit arm 26 disposed in perpendicular relationship to each other. A shaft 28 in the valve interior 24 is mounted on a shaft mount block 27. An O-ring 31 is normally biased by a spring 29 in an open position to facilitate free flow of gas from the gas entry arm 25 to the gas exit arm 26. A diaphragm 30 in the valve interior 24 may enclose the spring 29. The pressure controller 32 facilitates slidable extension of the shaft 28 through the shaft mount block 27 and engagement of the O-ring 31 against the valve body 23 to close the isolation valve 22 by facilitating the flow of clean dry air (CDA) through a port 36 in the valve body 23.

In the pressure servo state, the isolation valve 22 is in the fully-open position. By varying the positions of the valve disk 19 in the throttle valve 16 through the step motor (not shown), the pressure controller 32 regulates the conductance of the pumping line 14 and thereby adjusts the interior pressure of the process chamber 12 to establish and maintain the chamber pressure at the desired set point value. Simultaneously, the chamber pressure, monitored by the manometer 34, is continually compared with the set point pressure. The controller 32 responds to any differences by continually repositioning the valve disk 19 with respect to the direction of gas flow 33 through the throttle valve 16. In the idle state, the isolation valve 22 is fully closed and the throttle valve 16 is fully opened.

A common problem that is inherent in the conventional throttle valve 16 used in pressure servo systems 10 of plasma etchers is that polymer residues from the plasma gases flowing through the throttle valve are deposited on the valve disk 19 over time. This tends to damage the valve disk 19, interfere with the stability of gas flow through the valve body and compromise pressure stability in the etching chamber. A new and improved valve is needed which combines the gradual gas flow reduction functions of a throttle valve with the complete gas flow prevention function of an isolation valve, in a single device.

An object of the present invention is to provide a new and improved throttle valve which is suitable for a processing chamber for the fabrication of integrated circuits.

Another object of the present invention is to provide a fully-sealing throttle valve which combines the functions of a throttle valve and an isolation valve in one device.

Still another object of the present invention is to provide a throttle valve which is capable of precisely controlling interior gas pressures inside a processing chamber.

Yet another object of the present invention is to provide a throttle valve which is capable of both teminating flow of gas through a pumping line and impeding flow of gas through the pumping line to various degrees.

A still further object of the present invention is to provide a new and improved, fully-sealing throttle valve which is capable of reducing the polymer deposition-induced pressure servo failure rate which is characteristic of conventional throttle valves.

Yet another object of the present invention is to provide a new and improved throttle valve which is capable of a variety of applications including but not limited to controlling the pressure of gases inside a semiconductor processing chamber such as an etcher.

A still further object of the present invention is to provide a new and improved throttle valve which has a variety of industrial applications.

### SUMMARY OF THE INVENTION

In accordance with these and other objects and advantages, the present invention is generally directed to a new and improved fully-sealing throttle valve which is capable of selectively varying or stopping the flow of gas from one gas flow channel to an adjacent gas flow channel. The throttle valve includes a valve body in which is slidably disposed a tapered valve plug having a tapered plug sealing surface. A motor operably engages the valve plug for progressively moving the valve plug toward a correspondingly-tapered, complementary valve plug seat in the valve body in order to impede flow of gas between the plug sealing surface and the valve plug seat, through the valve body. The motor is capable of moving the plug sealing surface of the valve plug in firm engagement with the valve plug seat of the valve body to selectively prevent further flow of gas through the valve body.

### BRIEF DESCRIPTION OF THE DRAWINGS

The invention will now be described, by way of example, with reference to the accompanying drawings, in which:

FIG. 1 is a schematic view of a typical conventional pressure servo system for a dry etcher used in the semiconductor fabrication industry;

FIG. 2 is a schematic view of a conventional throttle valve used in the pressure servo system of FIG. 1;

FIG. 3 is a schematic view of a conventional isolation valve used in the pressure servo system of FIG. 1;

FIG. 4 is a schematic view of a pressure servo system for a dry etcher in implementation of the present invention;

FIG. 5 is a cross-sectional, partially schematic view of a fully-sealing throttle valve of the present invention, with the throttle valve shown in the open configuration;

FIG. 5A is an enlarged cross-sectional view illustrating partial constriction of a gas flow pathway through the throttle valve; and

FIG. 6 is a cross-sectional, partially schematic view of the fully-sealing throttle valve of the present invention, with the throttle valve shown in the closed configuration.

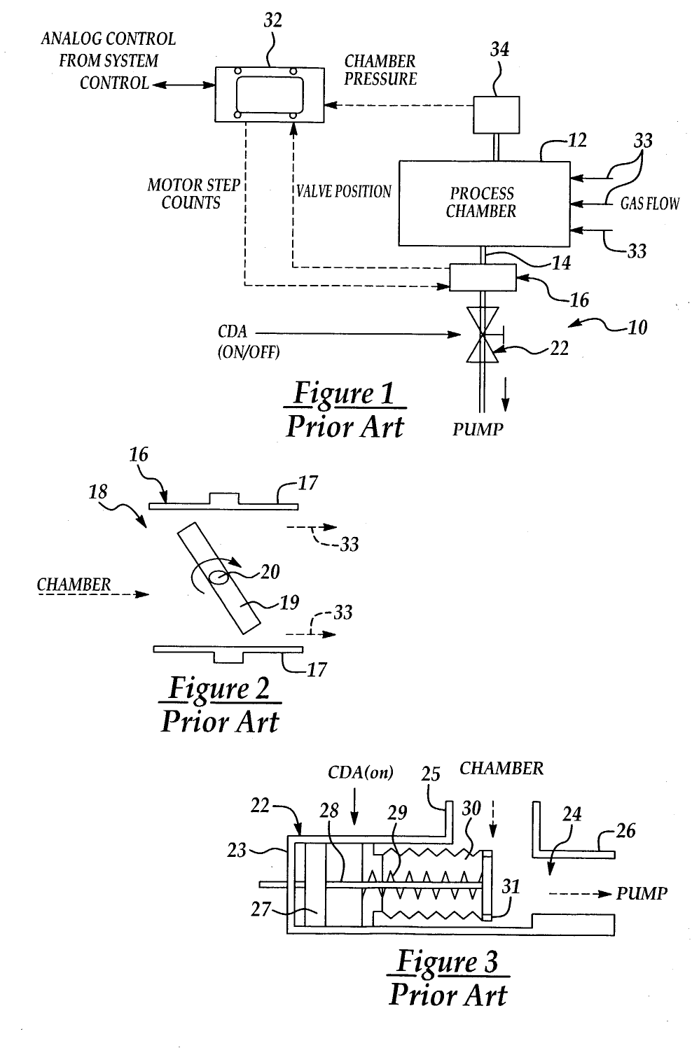

### DESCRIPTION OF THE PREFERRED EMBODIMENTS

The present invention has particularly beneficial utility in controlling gas pressures in a plasma etch chamber used in the fabrication of integrated circuits on semiconductor wafer substrates. However, the invention is not so limited in application and while references may be made to such plasma etch chamber, the invention is more generally applicable to controlling interior chamber pressures in a variety of industrial and mechanical applications. Furthermore, while the invention will hereinafter be described as regulating or preventing the flow of a process gas or gases from a process chamber to a pump, it is understood that the invention may be adapted for regulating or preventing the flow of a liquid between first and second conduits, containers or chambers.

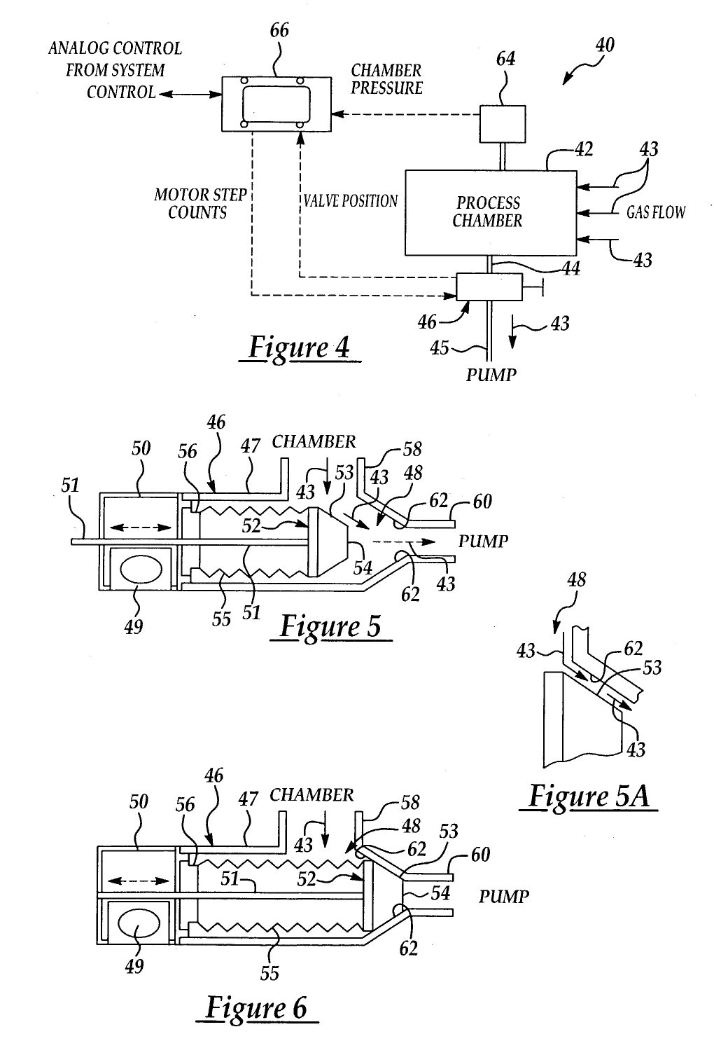

Referring initially to FIG. 4, a pressure servo system which incorporates a fully-sealing throttle valve 46 of the present invention is generally indicated by reference numeral 40. The pressure servo system 40 includes a pumping line 44 which leads from a process chamber 42. The process chamber 42 may be a dry etch chamber manufactured by the Lam Research Corp. of Fremont, Calif., for example, although the invention is equally applicable to other types of process chambers known by those skilled in the art. Accordingly, the process chamber 42 may be used to etch material layers from a semiconductor wafer substrate (not shown) placed in the process chamber 42 in the fabrication of integrated circuits on the substrate, as is known by those skilled in the art. A manometer 64 is connected to the process chamber 42 for measuring gas pressures therein. Process gases 43 are introduced into the process chamber 42 through one or multiple gas entry ports (not shown) typically provided in the side of the process chamber 42. As hereinafter further described, the throttle valve 46 of the present invention is provided in the pumping line 44 and is adapted for controlling the rate of flow of process gases from the process chamber 42 to a pump (not shown), thereby controlling the interior gas pressures of the process chamber 42. The throttle valve 46 is also capable of completely terminating or preventing flow of the process gases from the process chamber 42 to the pump, as needed. Accordingly, the fully-sealing throttle valve 46 is capable of assuming the function of both the conventional throttle valve and the conventional isolation valve, which are separate components of the conventional pressure servo system. A pressure controller 66 is operably connected to the actuating components of the throttle valve 46 and receives continuous input from the manometer 64 to control the interior gas pressures of the process chamber 42 through the throttle valve 46, as hereinafter described.

Referring to FIGS. 5 and 6, the fully-sealing throttle valve 46 of the present invention includes an elongated valve body 47 which may have a cylindrical or any alternative cross-sectional shape that is consistent with the use requirements of the throttle valve 46, to be hereinafter described. A gas entry arm 58 extends from the valve body 47, adjacent to one end thereof, and a gas exit arm 60 extends from the valve body 47, at the end thereof and typically in substantially perpendicular relationship to the gas entry arm 58. Alternatively, the gas entry arm 58 and the gas exit arm 60 may extend from opposite sides of the throttle valve 46, in linear or 180-degree relationship to each other. Both the gas entry arm 58 and the gas exit arm 60 communicate with a valve interior 48 defined by the valve body 47. A sloped, annular valve plug seat 62 is defined by the interior surface of the valve body 47, between the gas entry arm 58 and the gas exit arm 60. In operation of the throttle valve 46 as hereinafter described, the gas entry arm 58 is disposed in fluid communication with the pumping line 44 of the pressure servo system 40, whereas the gas exit arm 60 is disposed in fluid communication with an outlet line 45 that communicates with the inlet port (not shown) of the pump (not shown).

As further shown in FIGS. 5 and 6, a motor housing 50 which contains a typically electric motor 49 is provided on the valve body 47, typically at the end opposite the gas exit arm 60. An elongated valve stem 51 is operably engaged by the motor 49 for bidirectional linear movement of the valve stem 51 in the valve interior 48. The pressure controller 66 is operably connected to the motor 49 in such a manner as to actuate the motor 49 to move the valve stem 51 in a selected linear direction, as indicated by the double-headed arrow and according to the knowledge of those skilled in the art. A resilient valve plug 52, which includes an annular tapered plug sealing surface 53 and a circular, flat front surface 54, is provided on the extending end of the valve stem 51, inside the valve interior 48. The valve plug 52 may be a corrosion-resistant plastic or rubber such as neoprene, for example, and the slope angle of the plug sealing surface 53 matches and is complementary to the slope angle of the valve plug seat 62. An annular mount collar 56 may be provided on the motor housing 50, in the valve interior 48, in which case a flexible sheath 55 spans the valve plug 52 and the mount collar 56 and encloses the valve stem 51.

Referring next to FIGS. 4-6, in application the fully-sealing throttle valve 46 is capable of operation in each of three modes: the “pressure servo” mode, the “pump down” mode and the “idle” mode. In the “pump down” mode, the throttle valve 46 is in the fully-open position of FIG. 5, wherein the plug sealing surface 53 of the valve plug 52 is disposed in maximally-spaced relationship to the valve plug seat 62 of the valve body 47. In the “idle” mode, the throttle valve 46 is in the fully-closed position of FIG. 6, wherein the plug sealing surface 53 firmly engages the valve plug seat 62 and prevents the flow of process gases 43 from the process chamber 42, through the valve interior 48 and to the pump. In the “pressure servo” mode, to be hereinafter described in detail, the throttle valve 46 is between the fully-open position of FIG. 5 and the fully-closed position of FIG. 6 in order to achieve and maintain a selected set point pressure in the process chamber 42 during an etching or other process therein.

In operation of the throttle valve 46 in the “pressure servo” mode, the purpose of which is to achieve and maintain gas pressures in the process chamber 42 for the proper execution of an etching or other process therein, the pressure controller 66 is initially programmed to achieve and maintain a selected set point pressure for the interior of the process chamber 42, depending on the particular etching or other process to be carried out in the process chamber 42. As process gases 43 flow into the process chamber 42 through the gas entry ports (not shown) therein, the process gases 43 exit the process chamber 42 through the pumping line 44. The throttle valve 46 is initially in the open configuration shown in FIG. 5, wherein the plug sealing surface 53 of the valve plug 52 disengages and is spaced-apart from the valve plug seat 62 of the valve body 47. Accordingly, as shown in FIG. 5, the process gases 43 flow substantially unimpeded from the pumping line 44, through the gas entry arm 58 and the valve interior 48 of the valve body 47, respectively, to exit the valve interior 48 through the gas exit arm 60, and finally, enter the pump. Because the process gases 43 flow substantially freely through the throttle valve 46 to the pump, the initial pressures inside the process chamber 42 may be lower than the programmed set point pressure for the process, in which case the area available for gas flow between the plug sealing surface 53 and the valve plug seat 62 may require narrowing in order to impart additional resistance to the flowing process gases 43 and thereby increase the gas pressure inside the process chamber 42. The manometer 64 continually monitors the gas pressure inside the process chamber 42 and relays this information to the pressure controller 66. In the event that the actual gas pressure as indicated by the manometer 64 is lower than the set point pressure programmed into the pressure controller 66, the pressure controller 66 actuates the motor 49 of the throttle valve 46 to move the valve stem 51 to the right in FIGS. 5 and 6, in order to cause the plug sealing surface 53 on the valve plug 52 to approach the valve plug seat 62 of the valve body 47, and thereby narrow the area available for gas flow between the gas entry arm 58 and the gas exit arm 60 in the valve interior 48, as shown in FIG. 5A. This partially restricts the area available for flow of the process gases 43 through the valve interior 48, thereby increasing gas pressures inside the process chamber 42 in such a manner that the actual gas pressure read by the manometer 64 rises toward and eventually reaches the set point pressure programmed into the pressure controller 66. In the event that the actual gas pressure as read by the manometer 64 rises above the programmed set point pressure, the pressure controller 66 actuates the motor 49 to move the valve stem 51 to the left in FIG. 5, to widen or enlarge the area available for flow of the process gases 43 through the valve interior 48. This action reduces impedance imparted to flow of the process gases 43 to the pump, thereby correspondingly reducing gas pressures inside the process chamber 42 toward the set point pressure. By continually adjusting the distance between the plug sealing surface 53 and the valve plug seat 62 through actuation of the motor 49 in the foregoing manner, the pressure controller 66 maintains the gas pressures inside the process chamber 42 at the programmed set point pressure. In the event that it becomes necessary during or after the process to completely terminate or prevent flow of the process gases 43 from the pumping line 44, through the throttle valve 46 and to the pump, as in the pump idle state, the process controller 66 actuates the motor 49 to move the valve stem 51 to the right in FIG. 6 until the plug sealing surface 53 firmly engages the valve plug seat 62, thereby preventing flow of the process gases 43 through the valve interior 48, as shown in FIG. 6.

While the preferred embodiments of the invention have been described above, it will be recognized and understood that various modifications can be made in the invention and the appended claims are intended to cover all such modifications which may fall within the spirit and scope of the invention.

What is claimed is:

1. A throttle valve comprising:
a valve body having an entry opening and an exit opening;
a generally tapered valve plug seat provided in said valve body between said entry opening and said exit opening;
a generally tapered valve plug mounted for incremental bidirectional displacement in said valve body and removably engaging said valve plug seat; and
a valve actuation mechanism operably engaging said valve plug for displacing said valve plug in said valve body.

2. The throttle valve of claim 1 further comprising a valve stem engaging said valve plug and wherein said valve actuation mechanism operably engages said valve stem.

3. The throttle valve of claim 1 wherein said valve actuation mechanism comprises an electric motor.

4. The throttle valve of claim 3 further comprising a valve stem engaging said valve plug and wherein said valve actuation mechanism operably engages said valve stem.

5. The throttle valve of claim 1 wherein said generally tapered valve plug comprises an annular, tapered plug sealing surface and said valve plug seat has an annular configuration.

6. The throttle valve of claim 5 further comprising a valve stem engaging said valve plug and wherein said valve actuation mechanism operably engages said valve stem.

7. The throttle valve of claim 5 wherein said valve actuation mechanism comprises an electric motor.

8. The throttle valve of claim 7 further comprising a valve stem engaging said valve plug and wherein said valve actuation mechanism operably engages said valve stem.

9. A throttle valve comprising:
a valve body having an entry arm and an exit arm disposed at about a 90-degree angle with respect to said entry arm;
a generally tapered valve plug seat provided in said valve body at least partially between said entry arm and said exit arm;
a generally tapered valve plug mounted for incremental bidirectional displacement in said valve body and removably engaging said valve plug seat; and
a valve actuation mechanism operably engaging said valve plug for displacing said valve plug in said valve body.

10. The throttle valve of claim 9 further comprising a valve stem engaging said valve plug and wherein said valve actuation mechanism operably engages said valve stem.

11. The throttle valve of claim 9 wherein said valve actuation mechanism comprises an electric motor.

12. The throttle valve of claim 11 further comprising a valve stem engaging said valve plug and wherein said valve actuation mechanism operably engages said valve stem.

13. The throttle valve of claim 9 wherein said generally tapered valve plug comprises an annular, tapered plug sealing surface, and said valve plug seat has an annular configuration.

14. The throttle valve of claim 13 further comprising a valve stem engaging said valve plug and wherein said valve actuation mechanism operably engages said valve stem.

15. The throttle valve of claim 13 wherein said valve actuation mechanism comprises an electric motor.

16. The throttle valve of claim 15 further comprising a valve stem engaging said valve plug and wherein said valve actuation mechanism operably engages said valve stem.

17. A throttle valve comprising:
an elongated valve body having an entry opening and an exit opening at a first end of said valve body;
a generally tapered valve plug seat provided in said first end of said valve body, at least part of said valve plug seat extending between said entry opening and said exit opening;
a generally tapered valve plug mounted for incremental bidirectional displacement in said valve body and removably engaging said valve plug seat; and
a valve actuation mechanism provided in a second end of said valve body and operably engaging said valve plug for displacing said valve plug in said valve body.

18. The throttle valve of claim 17 further comprising a valve stem engaging said valve plug and wherein said valve actuation mechanism operably engages said valve stem.

19. The throttle valve of claim 17 wherein said valve actuation mechanism comprises an electric motor.

20. The throttle valve of claim 19 further comprising a valve stem engaging said valve plug and wherein said valve actuation mechanism operably engages said valve stem.
